(19) United States
(12) Patent Application Publication
(10) Pub. No.: US 2022/0225220 A1
(43) Pub. Date: Jul. 14, 2022

(54) METHOD AND APPARATUS FOR INITIAL ACCESS FOR REDUCED CAPABILITY DEVICES

(71) Applicant: Sierra Wireless, Inc., Richmond (CA)

(72) Inventors: Gustav Gerald Vos, Surrey (CA); Recep Serkan Dost, Richmond (CA); Steven John Bennett, Coquitlam (CA)

(21) Appl. No.: 17/574,920

(22) Filed: Jan. 13, 2022

Related U.S. Application Data
(60) Provisional application No. 63/136,926, filed on Jan. 13, 2021.

(51) Int. Cl. H04W 48/16; H04W 48/10; H04W 36/00; H04W 48/18

(52) U.S. Cl. CPC H04W 48/16; H04W 48/18; H04W 36/0077; H04W 48/10

(57) ABSTRACT

There is provided a method and apparatus for a method for initial access of a reduced capability (RedCap) device to a wireless network. The method includes receiving broadcast access permission information and determining an access permission status based on one or more characteristics of the RedCap device and the broadcast access permission information. The method further includes receiving, by the RedCap device, broadcast capability indication configuration information and determining a capability indication configuration based on the broadcast capability indication configuration information. The capability indication configuration is indicative of one or more messages to use for transmission of one or more capabilities of the RedCap device. The method further includes upon determination the access permission status indicates that the RedCap device is permitted to access to the wireless network, transmitting the one or more capabilities of the RedCap device via the one or more messages.

### CROSS-REFERENCE TO RELATED APPLICATIONS

This application claims the benefit and priority from U.S. Provisional Patent Application No. 63/136,926 filed Jan. 13, 2021, the contents of which are incorporated herein by reference in its entirety.

### FIELD OF THE INVENTION

The present invention pertains to the field of wireless communication and in particular to a method and apparatus for initial access for reduced capability devices.

### BACKGROUND

The 3^{rd} Generation Partnership Project (3GPP) has been working on the characteristics of a 5G New Radio (NR) user equipment (UE) with reduced capability (RedCap). Recently, characteristics of the RedCap 5G NR UE were discussed at the 3GPP Technical Specification Groups (TSG) Radio Access Network (RAN) meeting held on Dec. 11, 2011 (i.e. WI RP-202931). Some characteristics of the RedCap 5G NR UE include reduced bandwidth, a reduced number of antennas, half-duplex (HD) frequency division duplex (FDD), reduced mandatory maximum downlink (DL) modulation constellation order, and the maximum number of DL multiple-input and multiple-output (MIMO) layers matching with the number of the antennas.

In 5G NR Release 16 of the 3GPP specification, capabilities of UEs are transmitted through message 5 (msg5) during the initial access procedure. However, if the reduced capabilities of the UE are not known to the next generation NodeB (gNB) prior to receiving msg5, the gNB considers that all UEs (for example including legacy UEs) have minimal capabilities (for example, the gNB considers all UEs are to be treated as UEs with the most reduced capability) until the gNB receives msg5 which can include the information relating to the capabilities of the UE. It is understood that this is an option for some deployments, for example for some network configurations. However, transmitting details relating to the (reduced) capabilities of a UE through msg5 can result in longer connection time, increased power consumption (e.g. battery usage) and loss of spectral efficiency for all UEs.

Therefore there is a need for a method for initial access by a reduced capability device to a wireless network and a reduced capability device performing such method, that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a method for initial access by a reduced capability device to a wireless network, such as a 5G or New Radio (NR) network, and a reduced capability device performing such method.

In accordance with embodiments of the present invention, there is provided a method for initial access of a reduced capability (RedCap) device to a wireless network. The method includes receiving, by the RedCap device, broadcast access permission information and determining, by the RedCap device, an access permission status based on one or more characteristics of the RedCap device and the broadcast access permission information. The method further includes receiving, by the RedCap device, broadcast capability indication configuration information and determining, by the RedCap device, a capability indication configuration based on the broadcast capability indication configuration information, the capability indication configuration indicative of one or more messages to use for transmission of one or more capabilities of the RedCap device. The method further includes upon determination the access permission status indicates that the RedCap device is permitted to access to the wireless network, transmitting, by the RedCap device, the one or more capabilities of the RedCap device via the one or more messages.

In some embodiments, the one or more capabilities of the RedCap device include one or more of: bandwidth supported by the RedCap device; a number of antennas of the RedCap device; a duplexing mode utilized by the RedCap device; and a modulation capability of the RedCap device. In some embodiments, the one or more characteristics of the RedCap device include one or more of: bandwidth supported by the RedCap device; a number of antennas of the RedCap device; a duplexing mode utilized by the RedCap device; and a modulation capability of the RedCap device.

In some embodiments, the broadcast access permission information, the broadcast capability indication configuration information or both are acquired from system information blocks.

In some embodiments, one or more messages indicated by the capability indication configuration include one or more of a first message during the initial access of the RedCap device, third message during the initial access of the RedCap device and a message after the third message during the initial access of the RedCap device. In some embodiments, some of the one or more capabilities of the RedCap device are transmitted via the first message or the third message, and the remaining of the one or more capabilities of the RedCap device are transmitted via the message after the third message.

In some embodiments, the broadcast access permission information includes or excludes an access permission indication to indicate whether the RedCap device is permitted to access to the wireless network such that presence of the access permission indication is indicative of permission for the RedCap device to access to the wireless network and absence of the access permission indication is indicative of a rejection for the RedCap device to access to the wireless network.

In some embodiments, the initial access is repeated if the RedCap device performs one or more of: an idle mode inter-band reselection and a cell reselection.

In some embodiments, wherein the access permission status is further determined based on a subscription type of the RedCap device, the subscription type indicating whether the RedCap device subscribes to one or more of a home network, a preferred roaming network and another roaming network.

In some embodiments, one or more of the access permission status and the capability indication configuration is a bitmask.

In accordance with embodiments of the present invention, there is provided a reduced capability (RedCap) device. The device includes a processor and a machine readable memory storing machine executable instructions. The machine readable instructions, when executed by the processor configure the device to receive broadcast access permission information and determine an access permission status based on one or more characteristics of the RedCap device and the broadcast access permission information. The machine readable instructions, when executed by the processor further configure the device to receive broadcast capability indication configuration information and determine a capability indication configuration based on the broadcast capability indication configuration information, the capability indication configuration indicative of one or more messages to use for transmission of one or more capabilities of the RedCap device. The machine readable instructions, when executed by the processor further configure the device, upon determination the access permission status indicates that the RedCap device is permitted to access to the wireless network, to transmit the one or more capabilities of the RedCap device via the one or more messages.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 is a method for initial access of a reduced capability (RedCap) device or reduced capability UE to a wireless network, in accordance with embodiments of the present disclosure.

FIG. 2 is a schematic diagram of an electronic device, according to embodiments of the present disclosure.

It will be noted that throughout the appended drawings, like features are identified by like reference numerals.

### DETAILED DESCRIPTION

The present disclosure provides a method for initial access by a reduced capability device to a wireless network, such as a 5G or New Radio (NR) network, and a reduced capability device performing such method. According to embodiments, the method pertains to initial access procedure performed by a reduced capability (RedCap) device based on received broadcast information (e.g. broadcast access permission information, broadcast capability indication configuration information). It is to be understood that in the instant disclosure a RedCap device is a user equipment (UE) that has reduced capabilities. For example, a reduced capability UE can include such as a mobile device, machine-type-communication (MTC) device, machine-to-machine (M2M) equipment, or other device as would be readily understood.

Specifically, a RedCap device can determine an access barring status or access permission status based on broadcast access permission information that the RedCap device received from an associated base station, for example. The RedCap device can determine the access permission status based on one or more characteristics of the RedCap device. For example, the one or more characteristics of the RedCap device can relate to one or more of the bandwidth supported by the device, the number of antennas associated with the device, the modulation capability of the device and the duplexing mode of the device. The RedCap device can determine the best option for early indication to the base station, for example a gNodeB (gNB), of the configuration of the reduced capability of the RedCap device. The options for the early indication of the configuration of the reduced capability of the RedCap device can include one or more messages to be used for transmission of information related to capabilities of the RedCap device. For example, the one or more messages include one or more of the first message associated with the initial access procedure (e.g. msg1 indication configuration), the third message associated with the initial access procedure (e.g. msg3 indication configuration) and a message after the third message associated with the initial access procedure (e.g. msg5 indication configuration). Each indication configuration will be further illustrated below or elsewhere in this application.

Having regard to the messages (e.g. msg1, msg2, msg3, msg4, msg5) used in the initial access procedure, the following should be noted. In some embodiments of the present disclosure, for a 4-step random access channel (RACH) process, the first message in the initial access procedure may be a physical random access channel (PRACH) message from the device to the network, the second message may be the random access response message, and the third message may be the radio resource control (RRC) setup request message from the device to the network. In some embodiments of the present disclosure, for a 2-step random access channel (RACH) process, the message A may correspond to the first and third messages (e.g. msg1, msg3) of the 4-step RACH process illustrated above. While the method and apparatus are illustrated primarily using the first and third messages (e.g. msg1, msg3) of the 4-step RACH process in the present disclosure, a person skilled in the art would readily understand that message A can be similarly used, replacing the first and third messages (e.g. msg1, msg3) of the 4-step RACH process, when the initial access procedure is performed using the 2-step RACH process.

In various embodiments, the RedCap device can determine the best option for early indication of the configuration based on the broadcast capability indication configuration information that the RedCap device received from the base station, for example. Upon the determination that a RedCap device is permitted access, the RedCap device transmits its capabilities, for example, to the base station. The RedCap device can transmit the capabilities according to the best option determined for early indication of the configuration (e.g. using the first message during the initial access procedure, using the third message during the initial access procedure or using a message after the third message during the initial access procedure). The capabilities to be transmitted may include one or more of: the bandwidth supported by the device, the number of antennas associated with the device, the modulation capability of the device, the duplexing mode associated with the device or a combination thereof relating to one or more characteristics of the RedCap device. It should be noted that while the characteristics of the RedCap device and the capabilities of the RedCap device are similar and may overlap each other, the characteristics and the capabilities of the RedCap device can be clearly distinguished. As stated above, the characteristics of the RedCap device are used when the RedCap device determines the access permission status, and the capabilities of the RedCap device are the RedCap device's capability information that is transmitted to a base station, for example, by the RedCap device.

In some embodiments, the RedCap device receives the broadcast information (e.g. broadcast access permission information, broadcast capability indication configuration information) through the system information blocks (SIB). According to some embodiments, all of the RedCap device's capabilities can be exchanged no later than fifth message of the initial access procedure or msg5. It should be noted that not all UEs, for example UEs that may not be considered to be reduced capacity type devices, are required to follow this provision of capabilities thereof. In some embodiments, if the RedCap device executes or transitions into an idle mode, the reduced capability UE or RedCap device may be required to repeat the initial access procedure. Put another way, provided that transition into idle mode may result in an inter-band re-selection or a cell reselection for that RedCap device, the initial access procedure may need to be repeated if the RedCap device performs one or more of an idle mode inter-band re-selection and a cell reselection.

In some embodiments, a positive indication of permission for the RedCap device's (initial) access to the network is broadcasted over the communication network. As such, the presence of a positive indication in the broadcast information (e.g. broadcast access permission information) may indicate that the RedCap device is permitted to access to the network and the absence of a positive indication in the broadcast information (e.g. broadcast access permission information) may indicate that the RedCap device is rejected for access to the network. In some embodiments, permission for the RedCap device's access or barring is based on the subscription type associated with the RedCap device. For example, permission is granted only for a roaming network, a preferred roaming network, a home network or a combination thereof. In some embodiments where the capabilities of the RedCap device are transmitted using the third message of the initial access procedure (e.g. msg3 indication configuration), the transmitted capabilities may be formatted in 1, 2, 3 or 4 bits. In some embodiments, the RedCap device transmits some of the capabilities via the first and third messages (e.g. msg1 and msg3) of the initial access procedure, and further transmits the remaining of the capabilities via a message after the third message of the initial access procedure. In some embodiments, one or more of the access permission status and the capability indication configuration are in the form of a bitmask or determined using bitwise operations.

As stated above, the characteristics of a reduced capability (RedCap) 5G New Radio (NR) user equipment (UE) are discussed at the 3^{rd} Generation Partnership Project (3GPP) Technical Specification Groups (TSG) Radio Access Network (RAN) meeting held on Dec. 11, 2011 (i.e. WI RP-202931). One characteristic of a RedCap 5G NR UE is reduced bandwidth. Specifically, bandwidth is reduced to 20 MHz in Frequency Range 1 (FR1) for initial access and to 100 MHz in Frequency Range 2 (FR2). It may be noted whether the use of 40 MHz bandwidth is allowed in FR1 after the initial access by a RedCap device is to be determined in a future TSG-RAN meeting.

Another characteristic of a RedCap 5G NR UE is a reduced number of antennas. For example, the number of antennas may be reduced from two to one, from four to two, or from four to one. Further characteristics of a RedCap 5G NR UE is that a RedCap UE utilizes half-duplex (HD) frequency division duplex (FDD) instead of full-duplex (FD) FDD. Further characteristics of a RedCap 5G NR UE include that the reduced mandatory maximum downlink (DL) modulation constellation order is reduced from 256 quadrature amplitude modulation (QAM) to 64 QAM. A further characteristic of a Red Cap 5G NR UE is that the maximum number of DL multiple-input and multiple-output (MIMO) layers matches with the reduced number of the antennas (for example, given the above examples of reduced antennas the DL MIMO layers can be either 1 or 2).

Reduced capabilities of a UE can be indicated in message 1 (msg1) by using for example (physical random access channel (PRACH) preambles), msg3, msg5 or a combination thereof. However, each of these indication methods can have have disadvantages. Specifically, in the case of the RedCap indication through msg1, this indication method can be required to use separate PRACH space (for example PRACH partitioning is required) for the RedCap UEs. This required partitioning can result in waste of resources, for example spectral efficiency losses due to loss of trunking gains. Furthermore, the RedCap indication by msg1 can also require more broadcast signaling and have a complicated setup.

Regarding PRACH preambles, it may be noted that the 3GPP document (TS 38.321) describes PRACH preamble partitions. In particular PRACH preamble partitions are described in Section 5.1. Regarding PRACH information elements (IEs), it may be noted that the 3GPP document (TS 38.331) describes PRACH IEs. In particular PRACH IEs are described in Section A3.4 of the 3GPP TS 38.331.

In the case of the reduced capabilities of a UE are to be indicated in msg3, a reduced capability UE or RedCap device with one receive (Rx) antenna would have coverage issues relating to receiving DL and grant for the msg2. As such, the next generation NodeB (e.g. gNB) may need to increase the coverage for msg2, for example by using a lower modulation coding scheme (MCS) for all UEs, which can result in longer connection times (e.g. between the UE and the base station) and decreased spectral efficiency.

According to embodiments, msg2 and msg3 can be scheduled within 20 MHz or can be scheduled using cross-slot scheduling which allows a RedCap device or reduced capability UE to retune to another 20 MHz band. However, given the small size of these messages, (e.g. msg2 and msg3) significant scheduling issues (e.g. blocking or capacity) may not be triggered by restricting scheduling of msg2 or msg3. For example, the grants for msg2 and msg3 are located in control resource set zero (CORESET 0) which typically can be smaller than 20 MHz. After msg3 it can be advantageous for the base station to know if a UE is limited to 20 MHz because if it is not, the base station can have more flexibility in scheduling of msg4 and msg5 which can improve the efficiency of resource allocation. In other words, scheduling msg4 and msg5 may be challenging if scheduling of all UEs is constrained to 20 MHz until after msg5. In some embodiments, it can be beneficial that the communication network learns (e.g. the base station) that a UE is limited to 20 MHz upon or prior to receiving msg3. In this way, other UEs can be allowed to use more resources in msg4 and msg5. Otherwise, there can be capacity and/or blocking issues relating to the variety of different UE configurations communicating with the network, for example the base station.

It is noted that the 3GPP TS 38.331, Section 6.2.2 specifies that msg3 contains one spare bit. This msg3 configuration is at least in part defined below:

RRCSetupRequest ::= SEQUENCE {
rrcSetupRequest RRCSetupRequest-IEs
}
RRCSetupRequest-IEs ::= SEQUENCE {
ue-Identity InitialUE-Identity,
establishmentCause EstablishmentCause,
spare BIT STRING (SIZE (1))
}
InitialUE-Identity ::= CHOICE {
ng-5G-S-TMSI-Part1 BIT STRING (SIZE (39)),
randomValue BIT STRING (SIZE (39))
}

In the case of the reduced capabilities indication being sent in msg5 (for example which is defined for legacy UEs), any reduced capabilities of the UE will not be reported until message 5. This requires the network (for example base station or gNB) to consider all UEs (including legacy UEs) as having capabilities of the most limited reduced capability UEs (i.e. all UEs are treated as UEs with most reduced capability) until the base station, for example gNB (or network) receives msg5. In this regard, the network may allow only the most reduced capability of the UE until receipt of msg5. For a UE that does not have this level of reduced capabilities, by only allowing broader capabilities of the UE to be enabled upon receipt of msg5, the access resources associated with this broader capability UE have been wasted.

It is noted that the 3GPP TS 38.331 specifies msg5, wherein msg5 has been configured with room for future extensions. This msg5 configuration is at least in part defined below:

| UECapabilityInformation ::= | SEQUENCE { |
|---|---|
| rrc-TransactionIdentifier | RRC-TransactionIdentifier, |
| criticalExtensions | CHOICE { |
| ueCapabilityInformation | UECapabilityInformation-IEs, |
| criticalExtensionsFuture | SEQUENCE { } |
| } | |
| } | |
| UECapabilityInformation-IEs ::= | SEQUENCE { |
| ue-CapabilityRAT-ContainerList | UE-CapabilityRAT-ContainerList |
| OPTIONAL, | |
| lateNonCriticalExtension | OCTET STRING OPTIONAL, |
| nonCriticalExtension | SEQUENCE{ } OPTIONAL |
| } | |

It is also noted that whether HD-FDD is utilized should not affect the initial access of a device (e.g. UE) but networks may still block access to devices (e.g. UEs) that do not support HD-FDD.

Further details with respect to trade-offs in selecting capability indication in message 1, message 3 and message 5 (msg1, msg3, msg5) are illustrated in the 3GPP Technical report (TR) 38.875 (3rd Generation Partnership Project; Technical Specification Group Radio Access Network; Study on support of reduced capability NR devices (Release 17)) and the details in said document will be readily understood by a person skilled in the art.

Due to spectral efficiency decrease (which can increase cost per bit) and coverage loss, mobile network operators (MNOs) may not permit some reduced capability UEs to access their network or communicate on certain bands of their network. However, it is desired to have a solution that reduces or avoids signalling generated by the restricted capability UEs prior to msg5. It is desired that a solution does not require new functionality associated with legacy networks.

It is noted that as no single initial access procedure can satisfy all MNOs' needs, it is desired to have a variety of options for what a network can require reduced capability devices to perform for their initial access to the network. Provided there are a variety of options, network operators can select the best option for use on their network(s) in consideration of advantages and disadvantages associated with each option.

According to embodiments, there is provided a method for initial access by a reduced capability device (e.g. reduced capability UE) to a wireless network, such as a 5G or New Radio (NR) network, and a reduced capability device performing such method. Once a reduced capability device is synchronized to a band on a wireless network, the initial access procedure illustrated below can be performed, in accordance with embodiments of the present disclosure. For example, when a reduced capability UE has successfully decoded synchronization signal blocks (SSBs) and minimum system information, the reduced capability UE can initiate the initial access procedure.

### Initial Access Procedure—Permission

In 5G NR, access permission or access barring is configured using unified access control (UAC) that is broadcasted in system information block 1 (SIB1). The 3GPP Technical Specification (TS) 38.331, in Section 6.2.2, defines contents of the SIB1 containing the following information:

uac-BarringInfo SEQUENCE {

| | |
|---|---|
| uac-BarringForCommon | UAC-BarringPerCatList OPTIONAL, -- Need S |
| uac-BarringPerPLMN-List | UAC-BarringPerPLMN-ListOPTIONAL, -- Need S |
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN)) OF UAC- |
| | AccessCategory1-SelectionAssistanceInfo |
| } OPTIONAL - Need S | |
| } | |

The above information elements are defined in Section 6.3 of the 3GPP TS 38.331 and refer to lists used to determine whether a UE is barred. Section 5.2.2.4.2 of the 3GPP TS 38.331 describes how this SIB1 is used, by the UE, to determine barring. Further details of the initiation checks and barring are described in Sections 5.3.14.2 and 5.3.14.5 of the same document.

UAC is performed using access categories and access identities. The 3GPP TS 24.501, Section 4.5 defines access identities and has provision for new identities to be added. The 3GPP TS 22.261, Section 6.22 describes the many combinations of access identities and access categories. Already included are public land mobile network (PLMN), roaming, slicing, application, application server and core network (e.g. evolved packet core (EPC) or 5G core (5GC)). The extension of these access identities and access categories for reduced capability UE barring can be envisioned.

According to embodiments, a reduced capability (RedCap) device (e.g. reduced capability UE) receives broadcast access permission information and determines or checks for an access permission status or an access barring status based on the received broadcast access permission information. The broadcast access permission information may be acquired from (or included in) broadcasted system information blocks (SIBs) that the RedCap device receives. The received broadcast access permission information or the access permission information acquired from the broadcasted SIBs may include positive indications, negative indications or a combination thereof. Positive indications can be indicative of permission for a RedCap device's access to the network and negative indications can be indicative of rejection (i.e. disallowed or barred) of a RedCap device's access to the network. In some embodiments where only a positive indication (i.e. never includes a negative indication) is used to indicate whether the RedCap device is permitted for access to the network, the presence of the positive indication indicates that the RedCap device is permitted to access to the network, and the absence of the positive indication indicates that the RedCap device is rejected or barred from access to the network. In some embodiments where only a negative indication is used to indicate whether the RedCap device is permitted for access to the network, the presence of said negative indication indicates the RedCap device is rejected for access to the network, and the absence of said negative indication indicates that the RedCap device is permitted for access to the network.

As such and according to some embodiments, the non-presence of an indication of access permission status may be interpreted to be equivalent to an access barring status. Additionally, the non-presence of an indication access barring status may be interpreted to be equivalent to an access permission status.

Whether the device is permitted or rejected (for example barred) for access to the wireless network can be determined based on one or more of the following capabilities associated with the reduced capability UE or RedCap device:
whether the device supports 20 MHz bandwidth;
whether the device has 1 receive antenna;
whether the device has 2 receive antennas;
whether the device utilizes HD-FDD only (or not capable of utilizing FD-FDD);
modulation capability—maximum DL modulation capability is 64 QAM;
whether the device has capability for 40 MHz bandwidth limit after initial access.

In some embodiments, subscription-based permission or barring may be granted to the reduced capacity device. In other words, whether the reduced capacity device is permitted to or barred from the wireless network may be determined in consideration of the reduced capacity device's subscription type. For example, permission may be granted to a reduced capacity device subscribing to a roaming network, a preferred roaming network, a home network or a combination thereof.

In some embodiments, the permission or the access barring status may include a temporary barring information indication (for example, a parameter indicative of whether the barring information is temporary). When the RedCap device's or reduced capacity UE's access is not permitted on this band or network, the RedCap device or reduced capacity UE terminates the initial access procedure and should search and synchronize to another band or network. If the “temporary barring information indication” is set to indicate that the permission or barring information for the RedCap device is temporary, that RedCap device may be able to check the permission or the access barring status again after a relatively short period of time (e.g. after X minutes). On the other hand, if the “temporary barring information indication” is not set to indicate the permission or barring information for the RedCap device is temporary, then the RedCap device may consider the permission or the access barring status lasts a longer period of time (for example is semi-permanent). In this instance, the RedCap device can reset for checking on permission or access barring status only at re-boot or after a relatively long period of time (e.g. after Y days). In some embodiments, the RedCap device may be required to have up-to-date permission information or access barring status from the system information (SI) for a temporary access barring status. Legacy mechanisms to alert RedCap devices for changes in permission can also be used for updating temporary access barring status.

### Initial Access Procedure—Early Indication Configuration

According to embodiments, the RedCap device further proceeds to determine the best option for providing an early indication configuration indicative of the reduced capability of the RedCap device. A desired option may be determined based on the broadcast capability indication configuration information that the RedCap device receives. The RedCap device may receive the broadcast capability indication configuration information from a base station associated therewith.

According to embodiments, the options for the early indication configuration for the reduced capability of the RedCap device can include a msg1 indication configuration, a msg3 indication configuration and a post-msg3 indication configuration (e.g. msg5 indication configuration). Put another way, upon the determination that the access to the wireless network by the RedCap device is permitted, one or more capabilities of the RedCap device can be transmitted via one or more of a first message during the initial access procedure, a third message during the initial access procedure and a message after the third message during the initial access procedure. In some embodiments, the message after the third message of the initial access procedure is message 5 (msg5).

According to embodiments, a msg1 indication configuration can be based on one or more of the following RedCap device capabilities:
1a: supports 20 MHz bandwidth;
1b: has 1 receive (Rx) Antenna;
1c: has 2 receive (Rx) Antennas;
1d: the maximum downlink (DL) modulation capability is 64 QAM downlink (DL);
1e: utilizes HD-FDD only;
   It may be noted that whether the device supports 40 MHz bandwidth limit after initial access can be considered acceptable for initial access.

According to embodiments, if a reduced capability UE is configured to have one of the above capabilities, then the reduced capability UE may need to indicate the matching capability or matching capabilities in the first message (e.g. msg1) of the initial access procedure. In some embodiments, a bitmask broadcast in system information (for example a bitwise operation) can be used to indicate to the UE the one or more reduced capabilities (i.e. one or more of the above capabilities) that the UE need to report in the first message (e.g. msg1) of the initial access procedure.

If a RedCap UE's capability falls under any one of the capability categories indicated in the msg1 indication configuration (e.g. reported or indicated in the first message of the initial access procedure), the reduced capability UE must use a defined RedCap physical random access channel (PRACH) partition. The details of the RedCap PRACH partition(s) to use may be further signalled in the system information (SI). For example, a PRACH partition may be a subset of preambles, new time resources, new frequency resources or a combination thereof.

In some embodiments, a single PRACH partition can be configured. If only one PRACH partition is configured, the base station, for example gNB, can only be informed of one capability or one defined combination of capabilities or selected sets of capabilities as indicated in broadcast system information as designated to use the one PRACH partition. The base station can then consider all of the other reduced capability UEs (that do not use this PRACH partition) as if they are limited by the most performance restrictive characteristics that are not barred on that base station and not signalled in the one PRACH partition. For example, if the one PRACH partition is used to indicate only that a RedCap UE is accessing the base station it can consider that the reduced capability UEs have 1 Rx antenna and the other RedCap capability limitations because it has no other capability information. In some embodiments, a plurality of PRACH partitions for different capabilities can be also configured. Using more than one PRACH partition can allow a base station, for example gNB, to individually or separately treat or manage each UE, which has its own level of reduced capability (for example, each of the UEs have different restricted capabilities) prior to the third message (e.g. msg3) or the fifth message (e.g. msg5) of the initial access procedure. Groups of capabilities may be assigned the same or different PRACH partitions at the option of the network operator.

According to embodiments, in the case of msg3 indication configuration, whether a RedCap device would indicate its (reduced) capability information in the third message (e.g. msg3) of the initial access procedure may be based on the following RedCap device capabilities:
3a: supports 20 MHz bandwidth;
3b: has 1 receive (Rx) Antenna;
3c: has 2 receive (Rx) Antennas;
3d: the maximum downlink (DL) modulation capability is 64 QAM downlink (DL);
3e: utilizes HD-FDD only.

According to embodiments, for example, if a reduced capability UE is configured to have one of the above capabilities, then the reduced capability UE may indicate the matching capability or matching capabilities in the third message (e.g. msg3) of the initial access procedure. In some embodiments, whether the reduced capability UE has one of the above capabilities can be signaled via a bitmask (for example a bitwise operation) thereby indicating the matching capability or matching capabilities of the reduced capability UE in the third message (e.g. msg3) of the initial access procedure.

According to embodiments, if the reduced capability device has determined that it is to send its capability information in the third message (e.g. msg3) of the initial access procedure, the configuration for the format of the capability indication in the third message (e.g. msg3) of the initial access procedure, or msg3 indication configuration, can be provided to the reduced capability device in broadcast system information (SI). In some embodiments where msg3 indication configuration is used, the format of the indication may be 1, 2, 3 or 4 bits.

According to embodiments, in the case of post-msg3 indication configuration (e.g. msg5 indication configuration or legacy procedure), all reduced capability UE capabilities can be reported in a message after the third message of the initial access procedure (e.g. msg5) and any reduced capability UE limitations that are not previously reported (e.g. those not reported either in the first or third message of the initial access procedure (msg1 or msg3)) are to be reported in this message. In some embodiments, the feature of an optional extension to the configuration of the message after the third message (e.g. msg5) can be used in order to convey this information. A suitable extension to add sufficient bits to the message after the third message in the initial access procedure (e.g. msg5) for transmission of this desired information would be readily understood by a person skilled in the art.

In some embodiments, if the reduced capability device executes or enters into an idle mode (for example an idle mode inter-band re-selection, a cell reselection), the UE may be required to repeat the initial access procedure. It is understood that a RedCap device's transition into idle mode may result in an idle mode inter-band re-selection or a cell reselection for that RedCap device, and therefore the initial access procedure may need to be repeated.

### Detailed Implementation

According to embodiments, in order to avoid unnecessary random accesses to the network, a reduced capability device should not be permitted to access a base station (e.g. gNB) unless it has received an indication of permission. The indication of permission can be granted in the form of a positive indication. The presence of a positive indication may entail that the reduced capability UEs are permitted to access to the old base stations (e.g. gNBs). In at least some embodiments, the lack of the presence of this positive indication of permission may entail that the reduced capability device is barred for access to old base stations (e.g. gNBs) that have not been updated with regards to permissions for the reduced capability UE's access. The presence of a positive indication may be in the form of a single bit in system information that indicates that, in general, reduced capability UEs are allowed. Further details may be required to qualify limitations on the types of RedCap UEs that are permitted. The one bit may be an indicator of an optional extension of the broadcast system information that provides the more detailed barring information (i.e. permission information) and specific instructions for capability signalling to be followed in the first, third and fifth messages of the initial access procedure (e.g. messages 1, 3 and 5).

As stated above, no single initial access procedure would satisfy all MNOs' needs. As such, it is desired to have a generalized solution with a variety of options for what a network can require from the reduced capability devices to perform for their initial access to the communication network. While there can be significant flexibility, such a generalized solution may require a large amount of data (for example the transmission of a significant amount of information or bits) to be broadcasted for indicating the required capability configuration reporting of these reduced capability UEs. Provided that some options (e.g. selected combinations) are not required to be included in the options provided or are of a lower priority, some optimization of the potential options to be considered may be possible.

### Permission System Information

According to embodiments, a bit-mapped permission indication for all capabilities may include all possible combinations for the reduced capability devices subscribing to each of a home network, a preferred roaming network and other roaming network. For example, when there are five reduced capability device capabilities (e.g. capabilities listed above) for three subscription types (i.e. home, preferred roaming or other roaming), the total of 18 capability bits would be required. Three bits will be required for the indication of the subscription type (e.g. whether the subscription is made to a home network, a preferred roaming network or any network). The rest can be reserved for up to five additional capabilities for each of the three subscription types (i.e. 1 bit×5 capabilities×3 subscription types=15 bits).

An example of 18 capability bits allowing the maximum flexibility (i.e. covering plural possible combinations) is provided below. There are total of three 6-bit fields.
Field 1: 1 bit-20 MHz UEs with any subscription type allowed 5-bit barring capability field
Field 2: 1 bit-20 MHz UEs with Home subscription allowed 5-bit barring capability field
Field 3: 1 bit-20 MHz UEs with Preferred Roaming subscription allowed 5-bit barring capability field
   It may be noted that home subscription may be also referred to as home public land Mobile network (HPLMN) if the device has determined the public land mobile network (PLMN) is a HPLMN.

According to embodiments, an example of the 5-bit barring capability field is provided below.
1 bit—1 Rx antenna barred
1 bit—2 Rx antennas barred
1 bit—HD-FDD (not capable of FD-FDD) barred
1 bit—Modulation—maximum capability DL QAM 64 barred
1 bit—20 MHz bandwidth limit after initial access/acquisition barred
   It may be noted that whether the device supports 40 MHz bandwidth limit after initial access is not a problem for initial access. The capability for 40 MHz bandwidth limit after initial access may be an enhanced feature of some reduced capability devices that might be given preferred access.

As illustrated above, 18 bits would be required for the above case which covers all possible combinations. However, as many of the capability fields can be made optional (as shown below), some capability fields can be transmitted only when more specific permissions need to be set. While making the fields optional would take extra bits to specify which fields are to be sent, in practice, the required number of bits is often less because the configuration with full flexibility is often not required for most MNOs (e.g. not all of 18 bits would be needed for most MNOs).

According to embodiments, the following example is provided to illustrate how capability fields can be made optional. There are a total of three 6-bit fields.
Field 1: 1 bit-20 MHz UEs with any subscription type allowed 5-bit barring capability field (optional 1)
Field 2: 1 bit-20 MHz UEs with Home subscription allowed (optional 2) 5-bit barring capability field (optional 3)
Field 3: 1 bit-20 MHz UEs with preferred roaming subscription allowed (optional 4)
5-bit barring capability field (optional 5)

According to embodiments, an example of the optional 5-bit barring capability field is provided below.
1 bit—1 Rx antenna barred
1 bit—2 Rx antennas barred
1 bit—HD-FDD (not capable of FD-FDD) barred
1 bit—Modulation—maximum capability DL QAM 64 barred
1 bit—20 MHz bandwidth limit after initial access/acquisition barred

According to some embodiments, this may be structured to fit some provisioned spare positions in the existing barring structures in the 5G standards.

According to embodiments, when designing a capability field, for example barring capability field, the following factors should be considered as prioritized factors:
As devices with 1 Rx antenna or 2 Rx antennas provide decoding performance worse than devices with 4 Rx antennas, the devices with one or two Rx antennas would require more resources per bit and therefore would cost more resources per bit for service. As such, capability to block such devices (e.g. devices with one or two Rx antennas) is a priority.
Network operators (e.g. MNOs) often prefer to allow their “Home” subscribers and bar some or all roaming reduced capability devices. Alternatively, network operators may permit only certain types of roaming reduced capability devices, for example UEs with two or more antennas.
Being able to bar HD-FDD before attempting initial access is beneficial because resources do not have to be wasted by having the gNB process the access. This may be considered a secondary priority.

According to embodiments, the barring capability fields can be reduced to 3 bits in consideration of the above factors and priorities. An example of the 3-bit barring capability field is provided below:
1 bit—1 Rx antenna barred
1 bit—2 Rx antennas barred
1 bit—HD-FDD (not capable of FD-FDD) barred

### Early Indication Configuration in the First Message—msg1 Configuration

According to embodiments, the reduced capability device can acquire capability indication configuration information broadcasted from the base station (e.g. gNB) in order to determine whether the reduced capability device would indicate or report its capabilities in the first message (e.g. msg1) of the initial access procedure using PRACH partitioning. Upon reading the received broadcast capability indication configuration information with respect to msg1, the reduced capability device attempts to match its capabilities to the broadcast capability indication configuration information.

In various embodiments, a full set of configuration options may be provided including each of the following capabilities: 1 Rx antenna, 2 Rx antennas, 4 Rx antennas, 64 QAM DL and HD-FDD. It may be noted there is no need for a separate indication for 20 MHz bandwidth limitation.

According to embodiments, as the reduced capability device can have only one of 1 Rx antenna, 2 Rx antennas and 4 Rx antennas, there are 3 possibilities in terms of the number of Rx antennas (i.e. 1, 2 or 4). Also, provided that both 64 QAM DL and HD-FDD can be individually or jointly applied to any of the antenna combinations above, there will be four combinations for each antenna attribute option. Therefore, there can be a total of 12 possible combinations (i.e. 3*4=12) which can be signalled as a 12-bit bitmask. One example of the 12-bit bitmask with 12 possible combinations is provided below:

| | |
|---|---|
| 1 RX, NOT 64QAM, NOT HD | 0 or 1 |
| 1 RX, 64QAM, NOT HD | 0 or 1 |
| 1 RX, 64QAM, HD | 0 or 1 |
| 1RX, NOT 64QAM, HD | 0 or 1 |
| 2 RX, NOT 64QAM, NOT HD | 0 or 1 |
| 2 RX, 64QAM, NOT HD | 0 or 1 |
| 2 RX, 64QAM, HD | 0 or 1 |
| 2 RX, NOT 64QAM, HD | 0 or 1 |
| 4 RX, NOT 64QAM, NOT HD | 0 or 1 |
| 4 RX, 64QAM, NOT HD | 0 or 1 |
| 4 RX, 64QAM, HD | 0 or 1 |
| 4 RX, NOT 64QAM, HD | 0 or 1 |

According to embodiments, if a reduced capability device sees that its capabilities do not match one of the 12 broadcasted capability combination field bits that are set to 1, the reduced capability device would know that no reduced capability specific msg1 indications (e.g. reduced capability indications in the first message of the initial access procedure) are requested for it. Further, if this reduced capability device is not barred, then the reduced capability device does not need to use the msg1 indication or msg1 indication configuration and would use the legacy pool of random access channel (RACH) resources.

It may be noted that a person skilled in the art would readily understand that the signalling is required to define the mapping of one or more of the above combinations to a PRACH partition. Moreover, a person skilled in the art would also readily understand that the PRACH partition configuration needs to be broadcasted for each additional partition.

In some embodiments, an alternative variable structure can be established for the above 12 possible combinations in msg1 (e.g. first message of the initial access procedure), as follows:

```
Message1RedCapConfiguration = {
  Msg1CombinationFields (SIZE (0..12)) of Msg1CombinationField Optional
}
Msg1CombinationField = {
  AntennaConfiguration  (4Rx, 2Rx, 1Rx)  (2 bits)
  64QAMCapability  (false,true)  (1 bit)
HD-FDDCapability  (false,true)  (1 bit)
}
```

According to embodiments, if a reduced capability device sees that none of the 4-bit combination fields are broadcasted, the reduced capability device would know that no msg1 indications (e.g. reduced capability indications in the first message of the initial access procedure) are requested. Further, if a reduced capability device does not see its particular combination of capabilities broadcasted and it is not barred, then the reduced capability device does not need to use the msg1 indication. In either case, the reduced capability device would use the legacy pool of random access channel (RACH) resources.

According to embodiments, as some combinations may be barred for all reduced capability devices, some of the 12 possible combinations may not be required in some cases. Further, in some embodiments, there is no strong need for the following capabilities to be indicated in msg1: 4 Rx antennas, 64 QAM and HD-FDD. Instead, there is a stronger need to indicate in msg1 the capabilities for the reduced number of antennas (e.g. 1 Rx antenna or 2 Rx antennas), the reduced bandwidth (e.g. in the case of 4 Rx antennas) or both. This can be signalled with a 3-bit bitmask, for example as follows:

| | |
|---|---|
| 1 Rx antenna 20 MHz | 0 or 1 |
| 2 Rx antennas 20 MHz | 0 or 1 |
| 4 Rx antennas 20 MHz | 0 or 1 |

There may be some constraints imposed based on the frequency band used. For example, some bands in Frequency Range 1 (FR1) (up to 6 GHz) require 4 Rx antennas whereas some other bands in FR1 do not require 4 Rx antennas. In some embodiments, configuration options for capability reporting on applicable bands can be reduced using existing constraints imposed by the standards.

In some embodiments, the procedure may be further simplified by considering only the highest priority msg1 partitions gives the following possible options:
1 Rx antenna in FR1 bands that require 2 Rx antennas
2 Rx antennas in FR1 bands that require 4 Rx antennas
Only define one additional RedCap PRACH partition

When there is only one additional PRACH partition for reduced capability devices, no additional signalling is needed to define the mapping of one or more of the above combinations to the reduced capability PRACH partition. For each separate partition indicated, the specific PRACH partition defining information would be broadcasted.

Following is an example of 1-bit msg1 configuration for FR1 bands that do not require 4 Rx antennas:
1 Rx 20 MHz

Following is an example of 1-bit msg1 configuration for FR1 bands that require 4 Rx antennas:
2 Rx 20 MHz

Following is an example of 1-bit msg1 configuration for FR1:
<=2 Rx

Following is an example of 1-bit msg1 configuration:
20 MHz (all reduced capability devices)

### Early Indication Configuration in the Third Message—msg3 Configuration

According to embodiments, in order to determine whether the reduced capability device (e.g. reduced capability UE) would indicate its capability in msg3 (e.g. third message of the initial access procedure), the reduced capability device reads the broadcast capability indication configuration information with respect to msg3 (e.g. msg3 configuration) acquired for example from SI and match its capabilities to the msg3 configuration. If the reduced capability device's capabilities match to the msg3 configuration, then the reduced capability device would indicate or report the matching capabilities in msg3. If the reduced capability device's capabilities do not match to the msg3 configuration, the reduced capability device does not indicate or report its capabilities in msg3.

Similar to the case of msg1 (e.g. first message of the initial access procedure), if full configuration flexibility is to be provided, there can be a total of 12 possible combinations, which require 12 bits for signalling (e.g. signalled as 12-bit bitmask). However, such full flexibility is not required in most cases (e.g. some of the 12 possible combinations may be not required in some cases).

According to embodiments, if there are no capabilities indicated in msg1 (e.g. first message of the initial access procedure), in most cases, msg3 indication configuration would be required when the reduced capability device has a reduced bandwidth (e.g. 20 MHz FR1 or 100 MHz FR2). For example, the 1-bit variable structure for msg3 indication configuration can be established as follows:

Message3RedCapConfiguration :: = SEQUENCE { Optional
ReducedBW ENUMERATED(false,true)
}

In case the Message3RedCapConfiguration is not broadcasted, there is no capability indicated in msg3 (e.g. third message in the initial access procedure).

As another example, the 2-bit variable structure for msg3 indication configuration can be established as follows:

Message3RedCapConfiguration :: = SEQUENCE { Optional
ReducedBW ENUMERATED(ReduceBW, 1RX, 2RX)
}

In case that the Message3RedCapConfiguration is not broadcasted, there is no capability indicated in msg3 (e.g. third message in the initial access procedure).

According to embodiments, if the reduced capability device determined that it is to send its capability information in msg3 (e.g. determined that it is to indicate its capabilities in the third message of the initial access procedure), the configuration of the format of the indication(s) in msg3 is provided to the reduced capability device. There are 4 possible configurations for the msg3 indication format, as provided below:
1-bit format—the reduced capability device always sets to 1
2-bit format—e.g. enumerate (1RX, 2RX,1RX+64 QAM, 2RX+64 QAM)
3-bit format—a table to indicate more capability combinations
4-bit format—a table to indicate all possible capability combinations

It may be noted that a person skilled in the art would readily understand how to extend msg3 (e.g. third message of the initial access procedure) to add more bits. It may be also noted that the above configurations can be signalled using 2 bits.

In some embodiments, there is no capability indicated in msg1 (e.g. first message of the initial access procedure) or only a limited set of capabilities are indicated in msg1 (e.g. first message of the initial access procedure). In such cases, a full set of configuration options may be indicated in msg3 (e.g. third message of the initial access procedure) including each of the following capabilities: 1 Rx antenna, 2 Rx antennas, 4 Rx antennas, 64 QAM DL, HD-FDD. In this case, a similar set up of the configuration as defined above with respect to msg1 can be used for the indication of the capabilities of the reduced capability UE in msg3.

In some embodiments any capabilities already indicated in msg1 (e.g. first message of the initial access procedure) may be optionally indicated in msg3 (e.g. third message of the initial access procedure) again.

Currently, there exists one spare bit in definition of msg3.

In some embodiments, the one spare bit in msg3 (e.g. third message of the initial access procedure) could be used for indication of one specific capability or a specific combination of capabilities, if such uses are specified in the broadcast system information. It is understood that there would need to be included a mechanism for the reduced capability device to compare its capabilities with the UE capabilities broadcast indicated for use of the spare bit.

In some embodiments, for full flexibility, a 12-bit mask proposed for msg1 may be used for the 1-bit reporting of a selected combination of configurations. However, such full flexibility is not required in most cases. In contrast to the case of msg1 configuration where multiple PRACH partitions can be enabled to separately report more than one configuration, in the case of msg3 configuration, only one configuration or one combination of configurations can be indicated in msg3.

In various embodiments, an implementation can use the one spare bit in msg3 to indicate any reduced capability device. Such an implementation can cover the need to report the 20 MHz limitation for msg4 and msg5 (e.g. fourth and fifth messages of the initial access procedure).

In some embodiments where the 4-bit format is used, in order to cover all capability combinations, an extended msg3 indication needs to be 4 bits. Four bits can be used in msg3 to indicate the specific capabilities of the UE; 1 or 2 or 4 receive antennas, 64 QAM and HD-FDD. The alternative variable structure for msg1 is illustrated above or elsewhere in this application.

In various embodiments, the reduced bandwidth capability (e.g. 20 MHz) does not need to be separately indicated, as it is implied when reporting one or more of the above reduced capabilities.

### Early Indication Configuration in the Fifth Message—msg5 Configuration

According to embodiments, all capabilities may be indicated in msg5 (e.g. fifth message of the initial access procedure) as an extension of legacy signaling. Those skilled in the art would readily understand how to extend msg5 (e.g. fifth message of the initial access procedure).

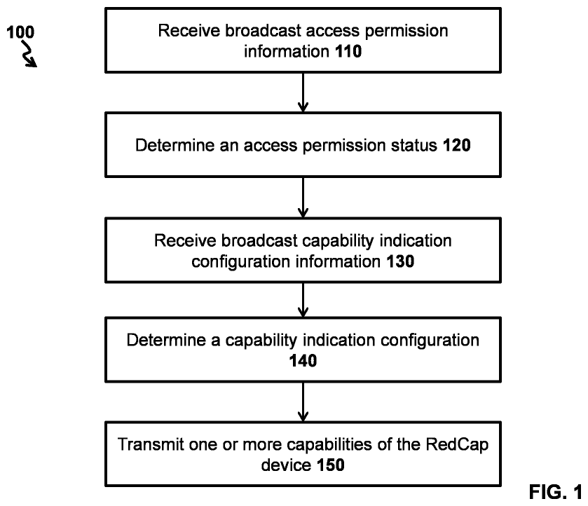

FIG. 1 is a method for initial access of a reduced capability (RedCap) device to a wireless network, in accordance with embodiments of the present disclosure. The method includes receiving 110 broadcast access permission information and determining 120 an access permission status based on one or more characteristics of the RedCap device and the broadcast access permission information. The method further includes receiving 130, by the RedCap device, broadcast capability indication configuration information and determining 140 a capability indication configuration based on the broadcast capability indication configuration information. The capability indication configuration indicative of one or more messages to use for transmission of the one or more capabilities of the RedCap device. Upon determination the access permission status indicates that the RedCap device is permitted to access to the wireless network, the method further includes transmitting 150 the one or more capabilities of the RedCap device via the one or more messages.

According to some embodiments, the one or more capabilities of the RedCap device include one or more of: bandwidth supported by the RedCap device; a number of antennas of the RedCap device; a duplexing mode utilized by the RedCap device; and a modulation capability of the RedCap device. According to some embodiments, the one or more characteristics of the RedCap device include one or more of: bandwidth supported by the RedCap device; a number of antennas of the RedCap device; a duplexing mode utilized by the RedCap device; and a modulation capability of the RedCap device.

According to some embodiments, the broadcast access permission information, the broadcast capability indication configuration information or both are acquired from system information blocks.

According to some embodiments, one or more messages indicated by the capability indication configuration include one or more of a first message during the initial access procedure associated with the RedCap device, third message during the initial access procedure associated with the RedCap device and a message after the third message during the initial access procedure associated with the RedCap device. According to some embodiments, some of the one or more capabilities of the RedCap device are transmitted via the first message or the third message, and the remaining of the one or more capabilities of the RedCap device are transmitted via the message after the third message.

According to some embodiments, the broadcast access permission information includes or excludes an access permission indication to indicate whether the RedCap device is permitted to access to the wireless network such that presence of the access permission indication is indicative of permission for the RedCap device to access to the wireless network and absence of the access permission indication is indicative of a rejection for the RedCap device to access to the wireless network.

According to some embodiments, the initial access procedure is repeated if the RedCap device performs one or more of an idle mode inter-band reselection and a cell reselection.

According to some embodiments, wherein the access permission status is further determined based on a subscription type of the RedCap device, the subscription type indicating whether the RedCap device subscribes to one or more of a home network, a preferred roaming network and another roaming network.

According to some embodiments, one or more of the access permission status and the capability indication configuration are a bitmask.

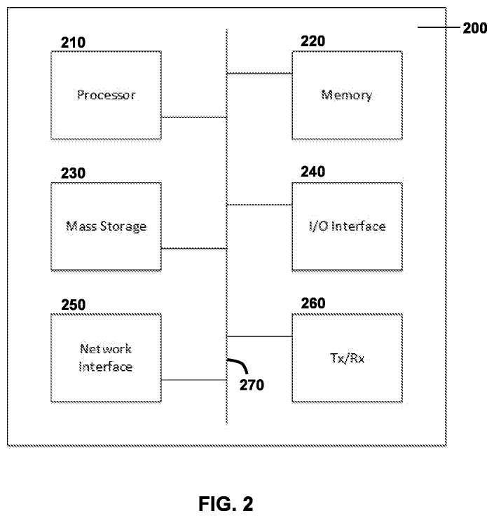

FIG. 2 is a schematic diagram of an electronic device 200 that may perform any or all of the steps of the above methods and features described herein, according to different embodiments of the present invention. For example, computer devices, wireless gateways, mobility routers, access point devices and core network devices, either virtualized or non-virtualized, can be configured as the electronic device. End-user computers, smartphones, IoT devices, etc. can be also configured as electronic devices.

As shown, the device 200 includes a processor 210, memory 220, non-transitory mass storage 230, I/O interface 240, network interface 250, and a transceiver 260, all of which are communicatively coupled via bi-directional bus 270. According to certain embodiments, any or all of the depicted elements may be utilized, or only a subset of the elements. Further, the device 200 may contain multiple instances of certain elements, such as multiple processors, memories, or transceivers. Also, elements of the hardware device may be directly coupled to other elements without the bi-directional bus.

The memory 220 may include any type of non-transitory memory such as static random access memory (SRAM), dynamic random access memory (DRAM), synchronous DRAM (SDRAM), read-only memory (ROM), any combination of such, or the like. The mass storage element 230 may include any type of non-transitory storage device, such as a solid state drive, hard disk drive, a magnetic disk drive, an optical disk drive, USB drive, or any computer program product configured to store data and machine executable program code. According to certain embodiments, the memory 220 or mass storage 230 may have recorded thereon statements and instructions executable by the processor 210 for performing any of the aforementioned method steps described above.

As described above and elsewhere herein, according to some embodiments there is provides a method and apparatus for initial access of a reduced capability (RedCap) device to a wireless network. In accordance with some embodiments, there is provided a method for initial access of a reduced capability (RedCap) device to a wireless network. The method includes receiving, by the RedCap device, broadcast information and determining, by the RedCap device, an access barring status based on one or more capabilities of the RedCap device and the broadcast information. Upon determination the access barring status indicates that the RedCap device is permitted to access to the wireless network, the method further includes determining, by the RedCap device, a capability indication configuration based on one or more capabilities of the RedCap device, the capability indication configuration indicative of capabilities of the RedCap device. The method further includes transmitting, by the RedCap device, the determined capability indication configuration.

In some embodiments, the broadcast information is information acquired from system information blocks. In some embodiments, the broadcast information includes one or more of a positive indication indicative of permission for the RedCap device to access to the wireless network and a negative indication indicative of a rejection for the RedCap device to access to the wireless network.

In some embodiments, the one or more capabilities of the RedCap device include one or more of: bandwidth supported by the RedCap device for the initial access; a number of antennas of the RedCap device; a duplexing mode utilized by the RedCap device; a modulation capability of the RedCap device; and bandwidth supported by the RedCap device after the initial access. In some embodiments, the access barring status is further determined based on a subscription type of the RedCap device, the subscription type indicating whether the RedCap device subscribes to one or more of a home network, a preferred roaming network and another roaming network.

In some embodiments, the capability indication configuration is associated with one or more of msg1, msg3 and msg5. In some embodiments, the capability indication configuration is associated with the msg1 or the msg3, and the capability indication configuration is a subset of possible capability indication configurations for the capabilities of the RedCap device. In some embodiments, the capability indication configuration is associated with msg3, and a format of the capability indication configuration includes 1 bit or 2 bits or 3 bits or 4 bits.

In some embodiments, initial access is repeated if the RedCap device transitions to an idle mode. In some embodiments, the determined capability indication configuration is transmitted before transmission of msg5.

In accordance with some embodiments, there is provided a reduced capability (RedCap) device. The device includes a processor and a machine readable memory storing machine executable instructions. The machine executable instructions, when executed by the processor configure the transmitting device to perform one or more of the above methods.

As will be readily understood by the description above, the terms base station and network node can be interchangeably used to define an evolved NodeB (eNB), a next generation NodeB (gNB) or other base station or network node configuration.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for initial access of a reduced capability (RedCap) device to a wireless network, the method comprising:
receiving, by the RedCap device, broadcast access permission information;
determining, by the RedCap device, an access permission status based on one or more characteristics of the RedCap device and the broadcast access permission information;
receiving, by the RedCap device, broadcast capability indication configuration information;
determining, by the RedCap device, a capability indication configuration based on the broadcast capability indication configuration information, the capability indication configuration indicative of one or more messages to use for transmission of one or more capabilities of the RedCap device; and
upon determination the access permission status indicates that the RedCap device is permitted to access to the wireless network, transmitting, by the RedCap device, the one or more capabilities of the RedCap device via the one or more messages.

2. The method according to claim 1, wherein the one or more capabilities of the RedCap device include one or more of: bandwidth supported by the RedCap device; a number of antennas of the RedCap device; a duplexing mode utilized by the RedCap device;
and a modulation capability of the RedCap device.

3. The method according to claim 1, wherein the one or more characteristics of the RedCap device include one or more of: bandwidth supported by the RedCap device; a number of antennas of the RedCap device; a duplexing mode utilized by the RedCap device;
and a modulation capability of the RedCap device.

4. The method according to claim 1, wherein the broadcast access permission information, the broadcast capability indication configuration information or both are acquired from system information blocks.

5. The method according to claim 1, wherein one or more messages indicated by the capability indication configuration include one or more of a first message during the initial access of the RedCap device, third message during the initial access of the RedCap device and a message after the third message during the initial access of the RedCap device.

6. The method according to claim 5, wherein some of the one or more capabilities of the RedCap device are transmitted via the first message or the third message, and the remaining of the one or more capabilities of the RedCap device are transmitted via the message after the third message. .

7. The method according to claim 1, wherein the broadcast access permission information includes or excludes an access permission indication to indicate whether the RedCap device is permitted to access to the wireless network such that presence of the access permission indication is indicative of permission for the RedCap device to access to the wireless network and absence of the access permission indication is indicative of a rejection for the RedCap device to access to the wireless network.

8. The method according to claim 1, wherein the initial access is repeated if the RedCap device performs one or more of an idle mode inter-band reselection and a cell reselection.

9. The method according to claim 1, wherein the access permission status is further determined based on a subscription type of the RedCap device, the subscription type indicating whether the RedCap device subscribes to one or more of a home network, a preferred roaming network and another roaming network.

10. The method according to claim 1, wherein one or more of the access permission status and the capability indication configuration are a bitmask.

11. A reduced capability (RedCap) device comprising:
a processor; and
machine readable memory storing machine executable instructions which when executed by the processor configure the device to:
receive broadcast access permission information;
determine an access permission status based on one or more characteristics of the RedCap device and the broadcast access permission information;
receive broadcast capability indication configuration information;
determine a capability indication configuration based on the broadcast capability indication configuration information, the capability indication configuration indicative of one or more messages to use for transmission of one or more capabilities of the RedCap device; and
upon determination the access permission status indicates that the RedCap device is permitted to access to the wireless network, transmit the one or more capabilities of the RedCap device via the one or more messages.

12. The device according to claim 11, wherein the one or more capabilities of the RedCap device include one or more of: bandwidth supported by the RedCap device; a number of antennas of the RedCap device; a duplexing mode utilized by the RedCap device;
and a modulation capability of the RedCap device.

13. The device according to claim 11, wherein the one or more characteristics of the RedCap device include one or more of: bandwidth supported by the RedCap device; a number of antennas of the RedCap device; a duplexing mode utilized by the RedCap device;
and a modulation capability of the RedCap device.

14. The device according to claim 11, wherein the broadcast access permission information, the broadcast capability indication configuration information or both are acquired from system information blocks.

15. The device according to claim 11, wherein one or more messages indicated by the capability indication configuration include one or more of a first message during the initial access of the RedCap device, third message during the initial access of the RedCap device and a message after the third message during the initial access of the RedCap device.

16. The device according to claim 15, wherein some of the one or more capabilities of the RedCap device are transmitted via the first message or the third message, and the remaining of the one or more capabilities of the RedCap device are transmitted via the message after the third message.

17. The device according to claim 11, wherein the broadcast access permission information includes or excludes an access permission indication to indicate whether the RedCap device is permitted to access to the wireless network such that presence of the access permission indication is indicative of permission for the RedCap device to access to the wireless network and absence of the access permission indication is indicative of a rejection for the RedCap device to access to the wireless network.

18. The device according to claim 11, wherein the initial access is repeated if the RedCap device performs one or more of an idle mode inter-band reselection and a cell reselection.

19. The device according to claim 11, wherein the access permission status is further determined based on a subscription type of the RedCap device, the subscription type indicating whether the RedCap device subscribes to one or more of a home network, a preferred roaming network and another roaming network.

20. The device according to claim 11, wherein one or more of the access permission status and the capability indication configuration are a bitmask.
